(19) United States
(12) Patent Application Publication
(10) Pub. No.: US 2009/0070317 A1
(43) Pub. Date: Mar. 12, 2009

(54) Patent claim and specification analysis

(76) Inventor: Richard Gordon Cooper, Costa Mesa, CA (US)

Correspondence Address: RICHARD G. COOPER, 725 CENTER ST., COSTA MESA, CA, 92627, US

(21) Appl. No.: 11/899,752

(22) Filed: Sep. 7, 2007

(51) Int. Cl. G06F 7/10; G06F 17/30

(52) U.S. Cl. 707/5; 707/E17.017

(57) ABSTRACT

This invention relates to providing automated support for the analysis of patents, patent applications and other texts, and more specifically, for supporting the analysis of claims in view of specifications, and for supporting claim analysis as compared to published texts that might constitute possible prior art or infringement of the patent.
Patent prosecution requires that the inventor, patent attorney, or patent agent carefully construct claims and specifications that delineate the invention according to well known principles of law. Patent licensing requires that documents describing products, services or methods which might infringe or invalidate a patent be organized in a clear style that can be presented to potential licensees. Patent litigation requires the analysis of patent claims against supporting statements in the patent specification, and against published technical literature which may or may not constitute prior art to the patent under analysis.
Present technology does not support automated assistance of these tasks due to the difficulty of processing natural language documents. The invention disclosed here describes methods, apparatus and systems for organizing patents and possible prior art documents in a manner that can be automated. The end result is a tool that ensures patent quality for prosecution, and which displays indefiniteness or incompleteness in patent specifications and prior art for inventors, patent examiners, evaluators, acquirers, licensors, licensees, prosecutors and litigators.

### BACKGROUND OF THE INVENTION

1. Field of Invention

This invention relates to providing automated support for the analysis of patents and patent applications and more specifically, for supporting the analysis of patent claims in view of the patent specifications, and for supporting claim analysis as compared to published materials that might constitute possible prior art or infringing products, services or technologies.

2. Description of Related Art

In this invention, a person of skill in the art is referred to as a Posita. There are two Positas mentioned in this invention: a subject matter Posita skilled in the art of the patent being analyzed, and a lexical software Posita skilled in the art of implementing software for processing lexical information, displaying the results, and navigating patent databases.

Words, sentences, paragraphs or other phrases are collectively or individually referred to as phrases. A claim chart is defined as having two or more columns, with each row containing a claim element in one column, and matching information in associated column(s). Each row in a claim chart contains one claim element in one column and one or more associated support or challenge phrase in other columns. A text is defined as being a patent document, a patent application document, a published article, or a document that could possible establish prior art or proof of infringement. Examples of texts include the HTML file which the USPTO patent database serves to a web browser, a user's manual, a maintenance manual, a scientific article, an encyclopedia entry, or other document describing information about a product, service or practice.

A support column is defined as a column in a claim chart which contains phrases that the Posita believes show definite descriptions for the associated claim element. A challenge column is defined as a column in a claim chart which contains phrases the subject matter Posita judges to infringe on the associated claim element.

Present software tools for assisting subject matter Positas are inadequate for generating full claim charts. There are tools that generate two and three column claim charts formatted in files that are compatible with word processing programs. For example, PatTools.com provides a tool that generates claim charts containing the claim elements in the first column, and two or three blank columns to be filled out by the operator. PatTools.com also provides a claim tree generator which takes as input a set of claims and produces a claim tree as output. PatentCafe.com provides a number of analysis tools, but no tools that can generate fully filled out claim charts. Like the PatTools.com and PatentCafe.com examples, present tools only address the claim elements and not the support columns or challenge columns. A completed claim chart requires that phrases in the specification which match terms in each claim element be displayed in the support and challenge columns. Presently, the subject matter Posita must make substantial manual efforts to fill in the support columns and the challenge columns of claim charts.

Present patent analysis tools do not provide support to a Posita in retrieving phrases from the patent specification, or from other texts, that match each claim element. Present software tools do not support flexibility in partitioning claim language into claim elements so that the Posita can organize claims into elements that suit the Posita's judgment about how these elements should be organized for comparison purposes.

### SUMMARY OF THE INVENTION

The present invention overcomes these and other deficiencies of the prior art by providing a method for organizing texts so that an operator can quickly select one or more claims, partition a claim into claim elements, and view sentences in the text which contain the information that is relevant to the selected claim element. In this way, the invention automatically generates claim charts that can assist an operator in tasks required for prosecution, litigation, infringement detection and portfolio evaluation.

To fill in a row in a patent, the Posita must find phrases in the text which are relevant to the associated claim element. Typically, these phrases use key words in the claim element that establish the claim. Phrases such as “comprising”, “including”, “said”, and other syntactic markers for claim elements are not considered relevant. The Posita must review the text to identify phrases with matching key words and organize the phrases into the claim chart to complete the claim chart where appropriate.

The present invention provides a method, apparatus, and computer readable medium with software for assisting the Posita in generating detailed claim charts.

In the Aug. 21, 2007 Federal Register, a change in the patent prosecution process was announced in finalized form. The changed process mandates that an Examination Support Document (ESD) be provided in certain prosecutions, primarily affecting the ways in which large enterprises prosecute patents, but also affecting small inventors who provide large numbers of claims. The new ESD requires claim charts for establishing the differences of an application as compared to prior art. The ESD appears to have been established to reduce the work load on USPTO examiners, and to more formally identify claim relationships with prior art. It is expected to improve the quality and validity of patent applications in the future.

One economic effect will be to increase the workload of patent prosecutors and consequently the cost of prosecution. The present invention will provide tools to assist in preparing claim charts for prosecutions requiring ESDs, thus reducing the cost of complying with the ESD requirements. Patent prosecution costs are significant in that few patents provide a return on investment that justifies the original expense of prosecuting the patent. The patent system works because the few that provide high returns generate large enough value to overcome the costs of prosecuting many patents to find the few which are very profitable. Therefore companies are hesitant to spend much money on prosecution of patents.

The present invention can help reduce the cost of patent prosecution, improve the quality of patent applications, reduce the work overload on examiners, and simplify any subsequent licensing and litigation projects.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a claim set, a claim tree extracted from the claim set, and a selected claim;

FIG. 2 shows a two column support claim chart for a selected claim; and

FIG. 3 displays a three column challenge claim chart for a claim element of a selected claim; and

FIG. 4 presents a stored file containing an HTML version of a claim chart rendered by a browser.

### DETAILED DESCRIPTION OF EMBODIMENTS

Further features and advantages of the invention, as well as the structure and operation of various embodiments of the invention, are described in detail below with reference to the accompanying FIGS. 14, wherein like reference numerals refer to like elements. The embodiments of the invention are described in the context of [describe particular application if appropriate]. Nonetheless, one of ordinary skill in the art readily recognizes that [insert generic statement of applicability of invention if greater than the context in which it is described].

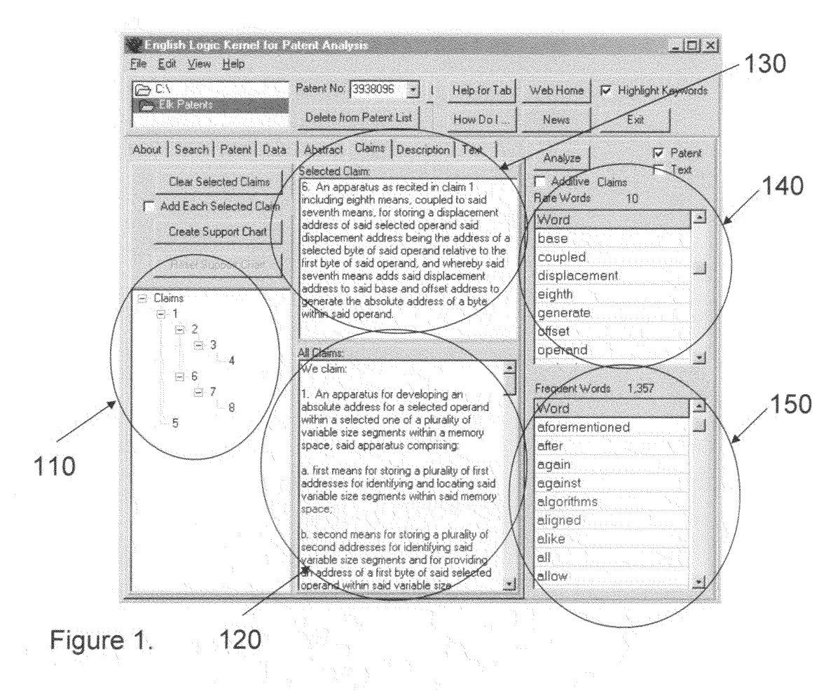

FIG. 1 illustrates a claim set 120, a selected claim 130, and a claim tree 110 extracted from the selected claim 130.

In an embodiment, patent HTML text can be retrieved from the USPTO web site by using a template URL. For U.S. Pat. No. 7,209,923, the URL as of this filing appears as follows:

http://patft.uspto.gov/netacgi/nph-Parser?Sect1=PTO1&Sect2=HITOFF&d=PALL&p=1&u=%2Fnetahtml%2FPTO%2Fsrchnu m.htm&r=1&f=G&1=50&s1=7209923.PN.&OS=PN/7209923&RS=PN/7209923

In the template URL above, the U.S. Pat. No. 7,209,923 appears three times in the URL. A lexical software Posita knows how to substitute a different patent number into the URL string three times, each time replacing one appearance of the U.S. Pat. No. 7,209,923.

In an embodiment, patent HTML text downloaded from the USPTO web site is used to provide the patent text. This form of patent text contains sections separated by the <HR> tag, and each section has a characteristic heading. By separating the various <HR> sections into individual texts, and identifying the characteristic heading for each text, the programmer is able to separate the data section, abstract, claim set and description into individual texts for further processing. In the HTML for U.S. Pat. No. 7,209,923, the <HR> appears eleven times, each time indicating a specific section. In other patents, the <HR> tag appears a different number of times. A lexical software Posita knows how to choose the nearby HTML text, store the various entries in a table of strings, and thereby create a dictionary of section headings that can be used to distinguish each section based on the heading it matches.

In an embodiment, the second <HR> in each HTML patent text is followed by the string “<font size=“+1”>” plus the title string plus the string “</font><BR>”+CRLF+”<BR><CENTER><B>Abstract</B></CENTER>”+CRLF+”<P>” plus the abstract string plus CRLF plus “</P>”. By extracting the variable entries in order from this string, the lexical software Posita can extract the title and abstract of an HTML patent text.

In another embodiment, two adjacent <HR> tags identify the data section of the HTML patent text in the example string below:

```
    <HR>
    <TABLE WIDTH=“100%”> <TR><TD VALIGN=“TOP”
ALIGN=“LEFT” WIDTH=“10%”>Inventors:
</TD><TD ALIGN=“LEFT” WIDTH=“90%”>
    <B>Cooper; Richard G.</B> (Costa Mesa, CA)
</TD></TR><TR><TD VALIGN=“TOP” ALIGN=“LEFT”
WIDTH=“10%” NOWRAP>Appl. No.:
    </TD><TD ALIGN=“LEFT” WIDTH=“90%”>
    <B>11/337,359</B></TD></TR>
      <TR><TD VALIGN=“TOP”
      ALIGN=“LEFT” WIDTH=“10%”>Filed:
      </TD><TD ALIGN=“LEFT” WIDTH=“90%”>
      <B>January 23, 2006</B></TD></TR>
    </TABLE>
    <HR>
```

By matching the sequence of HTML tags against a table, the lexical software Posita can extract the inventors, their cities, the patent application number and the filing date.

In still another embodiment, the remaining sections of the patent text can be extracted in ways that will be apparent to a lexical software Posita.

In yet another embodiment, the patent application number is 20070204220, and the URL required to access the application text is:

http://appft1.uspto.gov/netacgi/nph-Parser?TERM1 =20070204220&Sect1=PTO1&Sect2=HITOFF&d=PG01&D=1&u=%2Fneta html%2FPTO%2Fsrchnum.html&r=0&f=S&1=50

In this template URL, the string “20070204220” appears one time, and a lexical software Posita knows how to substitute a different patent application number into the URL and use it to retrieve the associated application text.

Application texts retrieved in this way also use the <HR> tag to separate sections of the application, but not in the same way that issued patent texts use the <HR> tag. A lexical software Posita understands how to apply the pattern matching techniques described in other embodiments above to extract the relevant sections of the application text.

Of particular interest in this invention, the published application claim set is usually bracketed by HTML tags:

<HR>
<CENTER><B><I>Claims</B></I></CENTER>
<HR>

The claim text follows the pattern above, and is followed in turn by <HR>. The claim text can be extracted after the preceding string and before the next <HR>.

In another common pattern, issued patent application HTML texts contain

<HR>
<CENTER><B><I>Claims</B></I></CENTER> <HR> <BR><BR>

followed by the claim set text, followed by <HR>. A lexical software Posita knows how to write software that explores multiple pattern matches for the observed string differences in bracketing claim sets as they vary among those HTML generators used by the USPTO web site to present patents and applications.

In an embodiment of the claims section, an initial claim statement such as “I claim”, “What is claimed is”, “We claim” and other common statements precede the numbered claims. A lexical software Posita understands that the digit “1” indicates the beginning of the first claim, while claim material prior to the digit “1” is extraneous material. In the remainder of this document, the term “claim set” will indicate the set of numbered claims extracted in this way.

In an embodiment, each patent claim can be individually extracted from the claim set by observing that the claim contains a number, often followed by a period, followed by the claim body, followed by a second period. With this pattern, the individual claim phrases can be extracted from the claim set. In some cases, a claim contains abbreviations with embedded periods or real numbers with embedded periods. A lexical software Posita knows how to write software that considers each alternative observed in the HTML generated by the USPTO web site. Each claim extracted using this embodiment will be referred to as a claim phrase in the remainder of this document.

In an embodiment, independent claims are those claims which mention no preceding claims by number. The string “claim” followed immediately by a numeric string, if present in a claim phrase, indicates that the claim phrase is a dependent claim, and that the claim on which it depends is the one which corresponds to the value of the numeric string.

In another embodiment, the software matches the dependency of a claim using the string “claims” followed by a set of numeric strings with embedded words drawn from the set “,”, “and”, “or” and followed by a word which is not in that set. In an embodiment, the dependency claim phrase extracted in this way is used to generate the dependent parts of the claim tree.

The beginning numeric string which precedes the first period in a claim phrase indicates the number of the claim within the claim set. In an embodiment, the claim tree 110 is displayed by constructing the tree of claims based on the claim number and on the dependency of each claim on earlier claims.

A lexical software Posita knows how to use Tree view components in programming environments such as Borland Delphi 7 to display the claim tree 110. In an embodiment, the programmer uses the functions provided with the Delphi TTreeView component to clear the claim tree, to construct the tree corresponding to the claim dependency structure, and to execute an event handler software function when the claim tree 110 elements are clicked with the mouse by a subject matter Posita.

A set of frequent words 150 is used to determine those words which are not relevant to the substance of the selected claim. When a selected claim 130 is analyzed to determine which words are rare words 140 for that claim, frequent words 150 are ignored in collecting the rare words 140. Corpus analysis experiments have identified that rare words can be selected to characterize each claim. The rare words 140 are matched against the patent specification to detect phrases containing rare words.

Frequent words are those which are commonly used in writing, but which are not considered to be “key” or “about” the text. “Key” or “about” words are referred to in this invention as “rare” words. Tribble's book [1] describes methods for determining which words in a text are good choices for the rare word lists. Both the subject matter Posita and the lexical software Posita are advised to read Tribble's book for guidance on selecting frequent and rare words.

In an embodiment, frequent words are those words which appear with the highest frequency in a pair of patents; one patent is the support patent and another patent is the challenge patent. Rare words are words which appear in the claim(s) being analyzed from the support patent and being challenged in the challenge patent text, but which are not included in the frequent word list.

In another embodiment, frequent words are those words which appear with the highest frequency in all patents in a class of patents. Rare words are words which appear in the claim(s) being analyzed from a support patent in the class and being challenged in the patent texts of other patents in the class, but which are not included in the frequent word list.

In yet another embodiment, frequent words are those words which appear in common technical texts describing the art being practiced by a support patent. Rare words are words which appear in the claim(s) being analyzed from the support patent, but which do not appear in the frequent word list.

In still another embodiment, the subject matter Posita chooses frequent words by editing the frequent word list before applying the operations described in this invention. The Analyze button 160 invokes a process for generating the list of rare words which appear in the claim(s) being analyzed from a support patent.

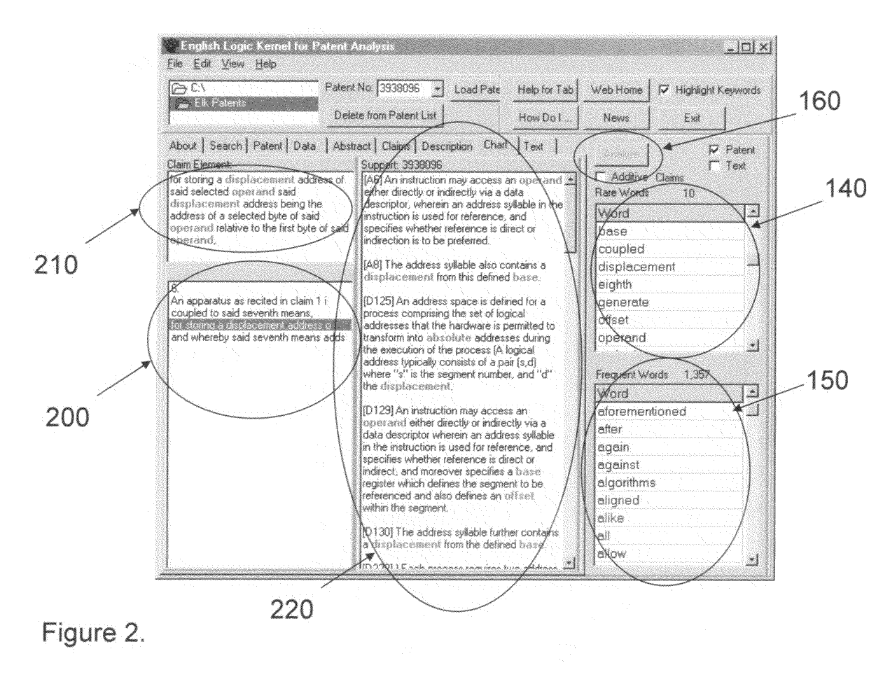

FIG. 2 shows a two column support claim chart for a selected claim 110 comprised of a display of the selected claim's elements 200 in list form, a display of one selected claim element 210 text, a support column 220, the frequent word list 150 and the rare word list 140.

In an embodiment, an Analyze button 160 executes a programmed event software function that takes the selected claim text, constructs a dictionary of all words in the claim text which are not also in the frequent words 150 and places the resulting word list into the rare words 140. A Posita of skill in writing lexical software knows how to implement this software function and assign it to the Analyze button 160 OnClick event. For example, the Borland Delphi 7 environment provides a process wherein programmers simply click on the component to generate the template software function. The programmer then enters a function body to perform the process.

In an embodiment, the claim phrases described earlier are analyzed to select rare words for further analysis of the text. Each claim phrase is separated into claim element phrases. In one embodiment, the subject matter Posita can edit the claim phrase to separate the phrase into claim elements.

In another embodiment, the lexical software Posita writes software that automatically generates a list of claim elements by searching for keywords that identify the syntax of claims. Key words include the following:

‘.’, ‘,’, ‘:’, ‘;’, ‘comprise’, ‘comprised’, ‘comprising’, ‘comprises’, ‘include’, ‘includes’, ‘including’, ‘wherein’, ‘and’, ‘or’.

In an embodiment, the lexical software Posita identifies common patterns used in claim phrases and writes software that organizes the common patterns into templates that are used to separate the claim phrase into claim elements. In another embodiment, the subject matter Posita edits the automatically generated claim elements to meet standards of claim chart elements.

In an embodiment, a programmed event software function is written to process the selected claim's selected element among the set of claim elements 200. In one embodiment, the list can contain the first few characters in each claim element to assist the subject matter Posita in choosing each element for display. The full text of the chosen claim element is presented in a rich text box 210 in one embodiment and the mm words contained in the chosen claim element are displayed 210 in a different font than that of the frequent words and other lexical items such as numbers. A Posita of skill in writing lexical software knows how to implement the event software function of the listbox displaying the set of claim elements 200.

In an embodiment, the lexical software written by a lexical software Posita comprises a lexical analyzer to partition the abstract and description texts into sentences, each of which is treated as a phrase for the purpose of matching phrases to claim elements. In an embodiment treating sentences as phrases, the analysis is based on finding candidate sentence terminators in the set of characters ‘.’, ‘!’, ‘?’. In a further embodiment, common phrases containing the terminator characters, such as ‘Mr.’, ‘Dr.’, ‘Drs.’, ‘Prof.’ ‘U.S.P.T.O’, and other common phrases, when found at the end of candidate sentences, are called ‘false terminators’ and are used to stop the lexical software from separating the text into phrases that are not true sentences. In still another embodiment the list of false terminators can be edited by the subject matter Posita to insert, edit or delete false terminators which may be encountered in a patent. In another embodiment, the lexical software displays a column number and row number estimate of where the matching sentence appears in the text.

In another embodiment, the lexical software partitions the text into paragraphs, and each paragraph is treated as a phrase for the purpose of matching. In one embodiment, each paragraph is identified by a terminating carriage return ASCII character, or a terminating line feed ASCII character, or another control character. In yet another embodiment, paragraphs can contain paragraph numbers like the one at the beginning of this paragraph, and the lexical software displays the paragraph number with the paragraph in a support column 220.

A support column 220 made from a rich text box is used in one embodiment to display the set of phrases which contain the rare words mentioned in the selected claim element 210 text. In an embodiment, all rare words must be in a phrase for that phrase to be displayed in the support column 220. In another embodiment, any rare word which appears in a phrase and also appears in the selected claim element 210 text causes that phrase to be displayed in the support column 220. In yet another embodiment, a phrase must contain a minimum number of rare words to be displayed in the support column 220. In still another embodiment, the subject matter Posita is presented with a menu of choices on how to select each phrase for display in the support column 220. In an embodiment, the subject matter Posita can insert, edit, copy, paste or delete phrases in the support column 220.

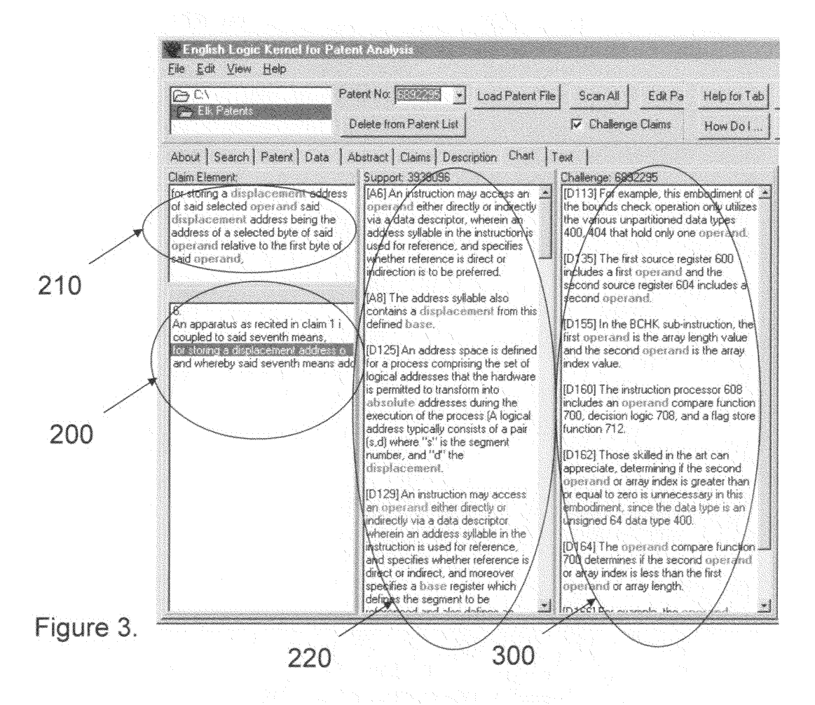

FIG. 3 displays a three column challenge claim chart for a claim element of a selected claim. In an embodiment, the selected claim's selected element among the set of claim elements 200, a display of one selected claim element 210 text, and a support column 220 are displayed as in FIG. 2. In an embodiment, the third column displays phrases that match the selected claim element 210 text, but which are taken from a text that is being used to challenge the claim on the basis of prior art. This embodiment can be useful for identifying possible prior art challenges. The text used for the third column display can be from material alleged to be earlier than the date required to invalidate the claim. In another embodiment, the text used for the third column display can be from material describing product(s) alleged to infringe the claim element.

A text used to fill in the challenge column 300 can also be used to defend the patent from charges of infringement by showing that the patent has certain claim elements which are required elements in the claim, yet which have no elements in the challenge material, which in that embodiment is provided by the defending counsel or Posita.

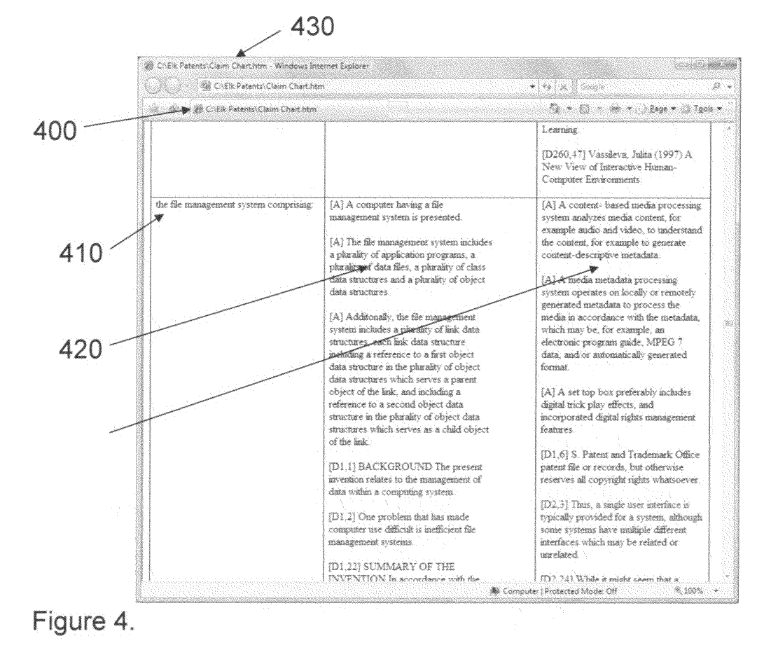

FIG. 4 presents an HTML version of a claim chart 400 rendered by a browser window 430. In an embodiment, the claim chart 400 is stored in HTML. In another embodiment, the claim chart is stored in a spreadsheet file. In still another embodiment, the claim chart 400 is stored in a word processor file. In an embodiment, the claim chart 400 is stored in Microsoft Word compatible HTML so that it can be edited with Word or with an HTML editor program.

An editable claim chart is a preferred embodiment for some applications because it allows the subject matter Posita to insert graphic images, photographs, video clips, audio clips, slide presentations or other presentation materials and to provide a clear description of the reasons why the claim element is or is not infringed by the material in the associated column. However, a claim chart as described in this invention need not be editable to practice the invention.

In another embodiment, the claim chart has a variable number of columns. For example, it is sometimes advantageous to associate claim elements of a support patent with a plurality of challenge patents, each challenge patent text being represented in a distinct column. In still another embodiment, the support patent is charted against a plurality of technical documents, and a plurality of challenge patents, and the combination of technical documents and patent texts are used to challenge the support patent.

In still another embodiment, a support patent claim is charted against a challenge patent claim or a plurality of challenge patent claims. This is useful for identifying how two patents intersect or differ in their claim elements, assisting an operator in evaluating the patents.

In an embodiment, an apparatus comprising a computer, display and printer which contain a software program for performing the methods described above constitutes an apparatus that can practice the invention.

In another embodiment, a computer readable medium containing a software program for executing the methods described above constitutes another way of practicing the invention.

In still another embodiment, an internet web server comprising a software program for executing the methods described above constitutes still another way of practicing the invention.

The invention has been described herein using specific embodiments for the purposes of illustration only. It will be readily apparent to one of ordinary skill in the am however, that the principles of the invention can be embodied in other ways. Therefore, the invention should not be regarded as being limited in scope to the specific embodiments disclosed herein, but instead as being fully commensurate in scope with the following claims.

I claim:

1. A method for analyzing a patent document including one or more claims and a specification, further comprising:
constructing a claim tree 110;
selecting one or more claims 130 in the claim tree:
choosing one or more key words 140 mentioned in the selected claims 130;
organizing each selected claim 130 into one or more claim elements 200, 210;
designating one claim element 200 among the one or more claim elements 200, 210; and
determining whether the designated claim element 200 contains at least one claim element word which matches at least one of the key words in the vocabulary of key words 140, wherein the method further comprises;
separating the specification into a plurality of phrases;
associating the designated claim element with one or more associated phrases in the plurality of phrases wherein each associated phrase contains at least one key word which matches at least one claim element word in the designated claim element; and
displaying the claim element together with its associated phrases 220 to an operator.

2. The method of claim 1 wherein the phrases are sentences or paragraphs.

3. The method of claim 1 further comprising:
printing or saving a claim chart in a file wherein:
each row of the claim chart comprises:
a claim element in a first column;
associated support phrases in a number N1 other columns; and
associated challenge phrases in a number N2 still other
columns
wherein
N1 plus N2 is greater than 0.

4. An apparatus that analyzes a patent document including one or more claims and a specification, comprising:
a component for constructing a claim tree 110;
a component for selecting one or more claims 130 in the claim tree;
a component for choosing one or more key words 140 mentioned in the selected claims 130;
a component for organizing each selected claim 130 into one or more claim elements 200, 210;
a component for designating one claim element 200 among the one or more claim elements 200, 210; and
a component determining whether the designated claim element 200 contains at least one claim element word which matches at least one of the key words in the vocabulary of key words 140, wherein the apparatus further comprises.:
a component for separating the specification into a plurality of phrases;
a component for associating the designated claim element with one or more associated phrases in the plurality of phrases wherein each associated phrase contains at least one key word which matches at least one claim element word in the designated claim element; and
a component for displaying the claim element together with its associated phrases 220.

5. The apparatus of claim 4 wherein the phrases are sentences or paragraphs.

6. The apparatus of claim 4 further comprising:
a component for printing or saving a claim chart in a file wherein:
each row of the claim chart comprises:
a claim element in a first column;
associated support phrases in a number NI other columns; and
associated challenge phrases in a number N2 still other
columns
wherein
N1 plus N2 is greater than 0.

7. A computer readable medium that stores a software program for analyzing a patent document including one or more claims and a specification, further comprising:
instructions for constructing a claim tree 110;
instructions for selecting one or more claims 130 in the claim tree;
instructions for choosing one or more key words 140 mentioned in the selected claims 130;
instructions for organizing each selected claim 130 into one or more claim elements 200, 210;
instructions for designating one claim element 200 among the one or more claim elements 200, 210; and
instructions for determining whether the designated claim element 200 contains at least one claim element word which matches at least one of the key words in the vocabulary of key words 140, wherein the computer readable medium further comprises;
instructions for separating the specification into a plurality of phrases;
instructions for associating the designated claim element with one or more associated phrases in the plurality of phrases wherein each associated phrase contains at least one key word which matches at least one claim element word in the designated claim element; and
instructions for displaying the claim element together with its associated phrases 220.

8. The computer readable medium of claim 7 wherein the phrases are sentences or paragraphs.

9. The computer readable medium of claim 7 further comprising:
instructions for printing or saving a claim chart in a file wherein:
each row of the claim chart comprises:
a claim element in a first column;
associated support phrases in a number NI other columns; and
associated challenge phrases in a number N2 still other
columns
wherein
N1 plus N2 is greater than 0.
